(19) United States
(12) Patent Application Publication
(10) Pub. No.: US 2014/0310033 A1
(43) Pub. Date: Oct. 16, 2014

(54) AIRLINE TICKETS UPGRADE SYSTEM

(71) Applicant: Christophe CAUVY, (US)

(72) Inventor: Christophe Cauvy, Oxford (GB)

(21) Appl. No.: 14/356,073

(22) PCT Filed: Nov. 5, 2012
(86) PCT No.: PCT/IB2012/056164

§ 371 Date: May 2, 2014

(30) Foreign Application Priority Data
Nov. 4, 2011 (GB) 1119095.6

(51) Int. Cl. G06Q 10/02; G06Q 30/08

(52) U.S. Cl. CPC G06Q 10/02; G06Q 30/08
USPC 705/5

(57) ABSTRACT

An auction server for auctioning airline ticket upgrades is described. The server comprises: an upgrade data gathering module for gathering data relating to available airline ticket upgrades for a specific airline flight; a communication interface for communicating auction information with existing airline ticket holders; the communication interface being arranged to receive at least one bid from at least one ticket holder for an airline ticket upgrade, and a bid analysis module for analysing the at least one bid for an airline ticket upgrade, the bid analysis module being arranged to determine a winning bid and its ticket holder to whom the airline upgrade ticket will be issued.

### FIELD OF THE INVENTION

The present invention concerns an airline tickets upgrade system which is used to provide upgrade tickets to existing ticket holders.

### BACKGROUND

Most airline companies operate flights with more than one class of ticket. Short and medium haul flights typically provide economy and business classes, while long haul flights usually introduce additional classes such as premium economy and first.

The difference in service between the classes is not only related to the size and comfort of the seat, the menus, the complementary drinks, the amenity bags and specially trained cabin crew: the increase in service extends to the flexibility of the ticket itself. Upper class ticket holders have more money at their disposal and often require more flexibility to accommodate changeable business schedules, while private individuals travelling for example in first class expect to have the convenience of late availability. To deliver this level of flexibility in the upper classes, supply is usually provided to exceed demand and planes often take off with empty seats in the upper classes. This is wasteful of resources and increases the resource and environmental cost per passenger of the flight. It also represents an opportunity cost to airlines and limits profitability.

At the same time, economy is frequently overbooked. This is in an effort to compensate just enough for no-shows to fill the plane, thereby maximising revenue through ticket sales. However, when more ticket holders turn up than expected, not all economy ticket holders can be accommodated. This leads to a degraded service and frustration on the part of the ticket holder.

There are strong financial incentives for airlines to fill seats. Known ways of trying to run a fully booked service include marketing and promotional campaigns. These are likely to contribute to the success of the business but since airlines often still have empty seats in upper classes this does not resolve the issue.

Flexible pricing models are also used in order to incentivise passengers to book using temporarily available discounts or other incentives. These are commonly used in the airline industry but do not resolve the issue.

Furthermore, marketing and pricing strategies do nothing to help the situation as it evolves in the hours before take off. It is during this window that an airline can see for the first time how many late bookings in the upper classes are made and how many economy ticket holders show up for the flight. Only then can an accurate picture develop of the distribution of ticket holders on that particular flight.

To address the issue of empty seats in upper classes, in some cases in combination with an overbooked economy, many airlines operate an upgrading policy. This allows ticket holders in the lower classes to upgrade to a higher class, including at the airport during the hours before take off. Upgrades are often priced so that the total cost of the existing ticket plus the upgrade is around the same as or a percentage less than the price of the higher class ticket.

However, upgrade sales are very limited. They are unpopular because the target market is ticket holders who either cannot afford a more expensive ticket or have already decided that the pricing of the higher classes is not worth the money. As a result, the pricing of upgrades is generally perceived by ticket holders as being expensive and only a small fraction of upgrades are usually sold.

On occasions, airlines will relieve pressure on an overbooked economy class by giving away free upgrades, especially to frequent flyers or members of their specific frequent flyer clubs or passengers with the highest levels of membership of those clubs.

In general, upgrades do not provide a good revenue stream for airlines. This is because the sale of upgrades is infrequent and because some upgrades are given away.

The known approaches inadequately address the issue of empty seats in superior classes—that is all classes except the lower class, in general known as “economy class”—on flights and as a result having empty seats in the upper classes remains common.

The invention seeks to address one or more of the deficiencies associated with the prior art.

### SUMMARY OF THE INVENTION

According to one aspect of the present invention there is provided an auction server for auctioning airline ticket upgrades, the server comprising: an upgrade data gathering module for gathering data relating to available airline ticket upgrades for a specific airline flight; a communication interface for communicating auction information with existing airline ticket holders; the communication interface being arranged to receive at least one bid from at least one ticket holder for an airline ticket upgrade, and a bid analysis module for analysing the at least one bid for an airline ticket upgrade, the bid analysis module being arranged to determine a winning bid and its ticket holder to whom the airline upgrade ticket will be issued.

The present invention resides in the appreciation that at least some of the problems described above can be alleviated by using an auction process to encourage sales of upgrades and as a result achieve greater efficiencies in the transportation of passengers on airline flights.

The communications interface may be arranged to communicate with existing airline ticket holders of the specific airline flight such that they are presented with an opportunity to bid on an upgrade on a flight for which they already have a ticket.

The communications interface may be arranged to communicate a deadline time for receiving a bid for the airline ticket upgrade.

Preferably the communications interface is arranged to notify the existing airline ticket holder of the outcome of the auction.

The communications interface can be arranged to send an existing ticket holder who has been successful in winning an upgraded airline ticket, an authentication upgrade code for use in confirming the success of the airline ticket holder to third party authentication devices.

The communications interface can advantageously be arranged to communicate via a web browser of a processing device of the ticket holder.

The communications interface may be arranged to communicate with a portable telecommunications device of the ticket holder.

Preferably the bid analysis module is arranged to determine whether any of the bids for upgrades on the specific airline flight have exceeded a predetermined threshold value and to prevent any ticket upgrade being issues if the threshold value has not been met by a highest bid.

Furthermore, the threshold value may be a value between a full price of an upgrade class of the auctioned ticket upgrade less the price already paid by the airline ticket holder and the price of a current class of the ticket held by the airline ticket holder less the price already paid by the airline ticket holder.

The bid analysis module is preferably arranged to determine whether any of the bids has been received before a deadline time which is set with respect to a departure time of the specific airline flight.

The bid analysis module can be arranged to analyse a plurality of bids for a plurality of airline ticket upgrades, determine a plurality of winning bids and match each winning bid to a corresponding airline ticket upgrade.

The upgrade data gathering module may be arranged to receive information relating to the specific airline flight, including a departure time of the specific airline flight.

The upgrade data gathering module may be arranged to obtain data relevant to ticket holders for the specific airline flight.

The upgrade data gathering module can be arranged to gather data from an airline ticketing system.

Alternatively or in addition the upgrade data gathering module can be arranged to gather data from a third-party ticketing system.

The auction server may further comprise an auction decision module for determining whether to run the airline ticket upgrade auction for a specific airline flight.

The auction server may further comprise an auction design module arranged to select an auction from the group comprising a forward auction, a reverse auction, a closed auction, an open auction, a Dutch Auction, and a Vickrey auction.

Preferably the auction design module is arranged to calculate a deadline time for the auction using a departure time of the specific airline flight.

The auction design module is, in an embodiment, arranged to determine the deadline time as 30 minutes before the departure time of the specific airline flight.

The auction server may further comprise a payment module for accepting payment for an upgrade airline ticket from a successful bidder, the payment module being arranged to use information obtained by the upgrade data gathering module.

Preferably the payment module is arranged to access a payment account of the successful bidder, details of which have been obtained from an airline ticketing system or a third-party ticketing system.

At least some of the embodiments of the present invention allow existing ticket holders to upgrade their airline ticket to a higher class by participating in an auction in which they can bid for an upgrade during the few hours before take off.

At least some of the embodiments of the present invention allow existing ticket holders to bid for more than one seat, for example for a couple or a family. Here the auction would be for a plurality of tickets for the airline flight on the basis of the same plurality of existing tickets.

At least some of the embodiments of the invention make it possible to generate incremental revenue on flights that have spare capacity in upper classes. For airline companies, this provides a source of efficiency since un-booked seats in upper classes may be sold, thereby freeing up seats in lower classes which in turn can be sold or allocated to standby passengers.

At least some of the embodiments of the invention provide incremental profits because the variable cost attached to the launch of an auction are low as most of the bidding process is automated. Moreover, the fixed cost of each flight does not increase because of the auction system.

In at least some embodiments of the invention, the variable costs attached to the services provided in upper classes, such as in-flight meals, complimentary drinks or “goodie bags”, can be offset for example by setting up a minimum bidding price that covers them.

In at least some embodiments of the invention, the only substantial investment to be made is upfront and consists mainly of developing an enterprise software solution on a multitude of platforms (such as PC, web-based, mobile phones, tablets, and interactive kiosks) that are connected to various databases (associated with the airline company's, credit card providers, and so on).

In at least some embodiments of the invention, the auction requires little marketing and sales expenses because the communication strategy is only aimed at existing ticket holders. This provides a precise and therefore cost-efficient targeting strategy.

In at least some of the embodiments of the invention, since the auction system improves capacity rates and better manages standby passengers, it reduces the likelihood that the airline company will have to compensate “bumped” or refused passengers on overbooked flights.

At least some of the embodiments of the invention improve customer satisfaction. Since passengers have the opportunity to upgrade at a price or bid that they chose, this price is likely to be perceived as affordable and fair if they win the auction since they selected the price in the first place. It is also a hassle-free way for existing ticket holders to upgrade.

For existing ticket holders, at least some of the embodiments of the invention are practical and easy to use because they involve no preparation or pre-registration; they provide a speedy solution that takes only a few minutes to agree to and participate in; they are run when passengers often have time to kill, while they are travelling to the airport or waiting to board their flight. In this regard, participants can bid on their mobile devices, while shopping, checking-in, going through customs, buying currencies, having lunch, and so on.

In at least some embodiments of the invention, an auction is operated directly or in-directly with a third party which already has a business relationship with the existing ticket holders. Therefore, these passengers are likely to trust the probity and fairness of the auction mechanism, and the level of security and safety with regards to the handling of their personal data.

With regards to customer service, by launching such a flexible, practical and cost-efficient solution for passengers, at least some embodiments of the invention are likely to help airline companies enhance their reputation and image, both with existing customers and prospective ones. Relatedly, at least some embodiments of the invention help airline companies add value to the overall series of services provided. The improved services on offer can become a strong differentiator in a highly competitive market, to the point where travellers may favour a specific airline company just because they know they will be offered the opportunity to bid for an upgrade.

At least some embodiments of the invention help to address environmental issues since upgrades free up more seats in lower classes, thereby potentially increasing the number of passengers per flight. This decreases fuel consumption and carbon footprint of the flight per passenger.

According to another aspect of the present invention there is provided a method of auctioning airline ticket upgrades to existing airline ticket holders, the method being implemented using a processor and comprising: gathering data relating to available airline ticket upgrades for a specific airline flight; communicating auctioning information to existing airline ticket holders; receiving and analysing at least one bid from a ticket holder directed to an airline ticket upgrade; determining a winning bid and its ticket holder to whom the airline upgrade ticket will be issued.

Preferably the communicating step comprises communicating with existing airline ticket holders of the specific airline flight such that they are presented with an opportunity to bid on an upgrade on a flight for which they already have a ticket.

According to another aspect of the present invention there is provided a communications device for interacting with an auction of airline ticket upgrades, the device being arranged to communicate auction information to and from an auction server and the device comprising: an auction alert module for receiving notification of the existence of the auction of airline ticket upgrades for a specific airline flight; a review and bidding module for creating at bid for the existing ticket holder for an airline ticket upgrade and sending the same back to the auction server; and an auction result module for presenting an outcome of the bid received from the auction server.

Preferably the review and bidding module is also arranged to present information about the auction and its rules and is arranged to receive an acceptance of the rules from the device user.

The auction result module may be arranged to provide instructions to enable collection and payment for an airline ticket upgrade for a successful airline ticket upgrade bid.

The communications device may further comprise a database for storing auction information relating to submitted bids and bid results.

The database may be arranged to store a unique authentication code received from the auction server which is to be used to authenticate the successful bid in order to receive the upgrade airline ticket.

Preferably the device comprises a smart phone or tablet computer and the auction alert module, the review and bidding module, and the auction result module are provided by a downloadable application for configuring the smart phone or tablet computer.

The present invention also extends to a combination of an auction server as described above and a communications device as described above.

According to another broader aspect of the present invention, there is provided an auction server for auctioning event ticket upgrades, the server comprising: an upgrade data gathering module for gathering data relating to available ticket upgrades for a specific event; a communication interface for communicating auction information with existing event ticket holders; the communication interface being arranged to receive at least one bid from at least one event ticket holder for an event ticket upgrade, and a bid analysis module for analysing the at least one bid for an event ticket upgrade, the bid analysis module being arranged to determine a winning bid and its ticket holder to whom the event upgrade ticket will be issued.

### DESCRIPTION OF THE FIGURES

The invention will be further described, by way of example, with reference to the accompanying drawings in which:

FIG. 1 is a schematic block diagram showing elements of an embodiment of the invention including an auction server having an auction database, an airline computer system having an airline database, a third party domain having a third party database, a personal user device having a user database, a public terminal and a communication network;

FIG. 2 is a schematic block diagram showing further detail of the auction server of FIG. 1;

FIG. 3 is a schematic block diagram showing further detail of the auction database of FIG. 1;

FIG. 4 is a schematic block diagram showing further detail of the airline database of FIG. 1;

FIG. 5 is a schematic block diagram showing further detail of the personal user device of FIG. 1;

FIG. 6 is a schematic block diagram showing further detail of the user database of FIG. 1;

FIG. 7 is a flow diagram showing activities of the auction server of FIG. 1 during an auction process performed by the embodiment of FIG. 1; and

FIG. 8 is a flow diagram showing activities at the personal user device of FIG. 1 during the auction process of FIG. 7.

### DETAILED DESCRIPTION OF SPECIFIC EMBODIMENTS

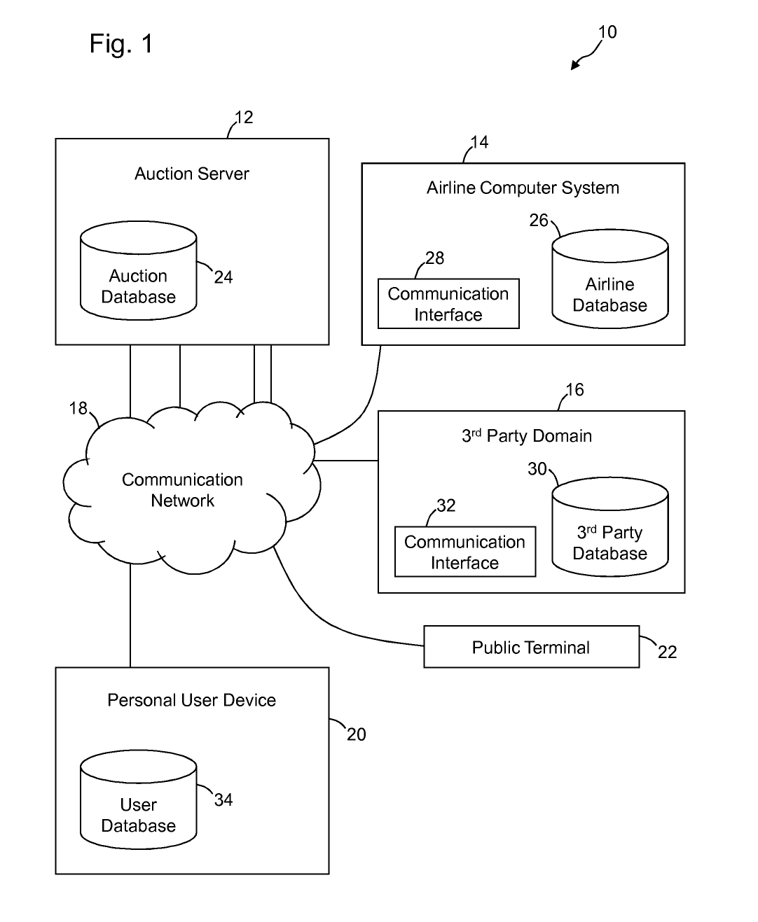

Referring to FIG. 1, an embodiment of the invention provides an airline ticket upgrade system 10 including an auction server 12 in communication with an airline computer system 14 and a third party domain (system) 16. As shown, the auction server 12 is coupled to each of the airline computer system 14 and the third party domain 16 by a communication network 18. The auction server 12 is arranged to set up and manage the auctioning of airline ticket upgrades for existing ticket holders booked onto a particular flight by obtaining and processing data from the airline computer system 14 and the third party domain 16, and by processing bids from the ticket holders.

A personal user device 20 and a public terminal 22 are also in communication with the auction server 12. The personal user device 20, provided as a smartphone in this embodiment, enables a ticket holder to engage in the auctioning process and to place bids for selected upgrades. User access to the auctioning process is provided either by the smartphone's browser, or by a dedicated application (app) downloaded to the smartphone. The personal user device 20 includes a user database 34 for storing various data for engaging with an upgrade auction. In an alternative approach, a ticket holder may engage in the auction using a browser of the public terminal 22. Here the equivalent of the user database 34 may be provided by central storage of the details relating to an account of the user (not shown).

The auction server 12 includes an auction database 24 storing various rules and data for setting up and running an upgrade auction. The auction database 24 may download specific data from an airline database 26 of the airline computer system 14 to provide further input data for the auctioning process. Data from the airline database 26 can be transmitted to the auction server 12 by a communication interface 28 of the airline computer system 14. Similarly, data in a third party database 30 of the third party domain 16 can be transmitted by the communication interface 32 to the auction server 12 for processing during an auction. The third party domain 16 may, for example, be provided as a travel agent booking engine such as ‘Galileo’ or ‘Amadeus’ or another computer system.

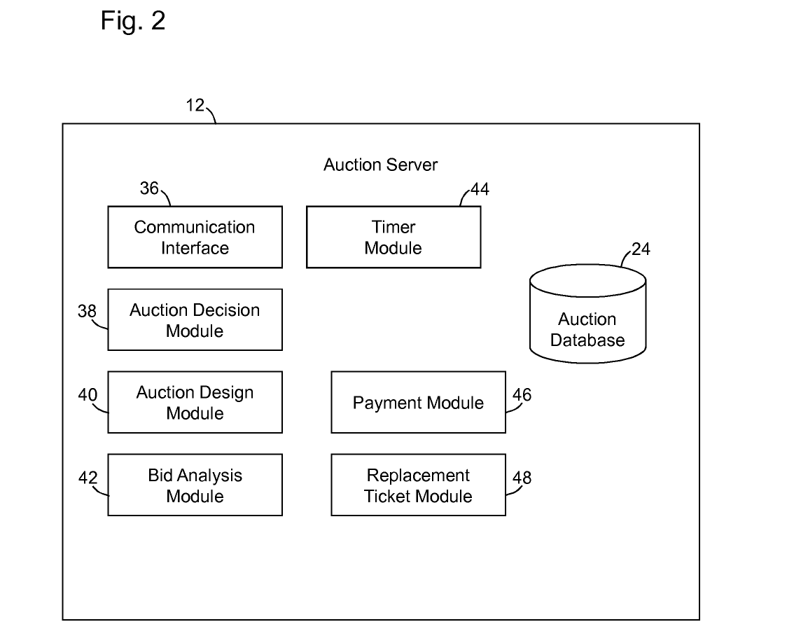

Referring to FIG. 2, the auction server 12 is provided with a communication interface 36 for communications via the communication network 18, and with various processing modules, as well as the auction database 24. An auction decision module 38 is provided for deciding whether to run an auction for a particular flight. If the decision is to run an auction, the auction decision module 38 also determines when ticket holders for that flight should be alerted that an auction will be held. In order to decide whether to run the auction, the auction decision module 38 makes use of various rules and data stored in the auction database 24, described further below. If an auction is to be run, the auction design module 40 sets the various parameters of the auction in order to define the auction fully.

The auction server 12 is further provided with a bid analysis module 42 for analysing received bids and determining winning bids and new seat allocations according to sets of rules stored in the auction database 24. The bid analysis module 42 refers to a timer module 44 in order to check that all bids were received by the deadline. Any bids received after the deadline are not evaluated, and are disqualified from the auctioning process. The auction server 12 also has a payment module 46 for requesting and receiving payment from winning bidders and for authorising replacement tickets to be issued according to the associated upgrade. A replacement ticket module 48 is provided for providing instructions to winning bidders on how to collect their new tickets. The replacement ticket module can also issue a unique identifier (for example in the form of a QR code) which can be provided to the successful bidding ticket holder for use verifying that they have won the auction and should now receive the upgrade.

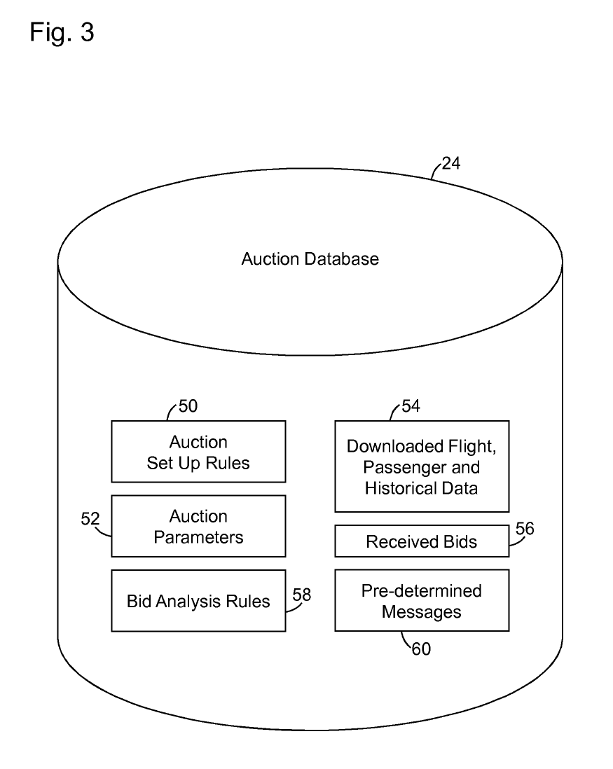

Referring to FIG. 3, the auction database 24 stores a range of information describing how to set up and run upgrade auctions, as well as more specific data relating to live or potential auctions for upcoming flights. For example, auction set up rules 50 define the circumstances in which an auction should be run, and if an auction is to be run, then how to design the auction. The auction set up rules 50 are referred to by the auction decision module 38 and the auction design module 40 when analysing a flight for a potential auction and when designing an auction. The parameters that are to be set when designing an auction are stored as auction parameters 52, and include the typology of the auction (for example forward, reverse, Dutch, Vickrey), the number and type of upgrades that are available, the minimum bidding price, the bidding deadline, payment options (which may include payment by credit card, cash, frequent flyer points or miles), and the deadline and process for paying successful bids and collecting upgrades. Relevant data obtained from the airline database 26 is stored in the auction database 24 as downloaded flight, passenger and historical data 54, and is available for processing by the auction decision module 38 and auction design module 40 as they carry out their respective decision and design functions.

Received bids 56 are stored in the auction database 24, together with bid analysis rules 58 defining how to analyse them. Pre-determined messages 60 are also stored as standard messages for informing bidders of the outcome of their bid.

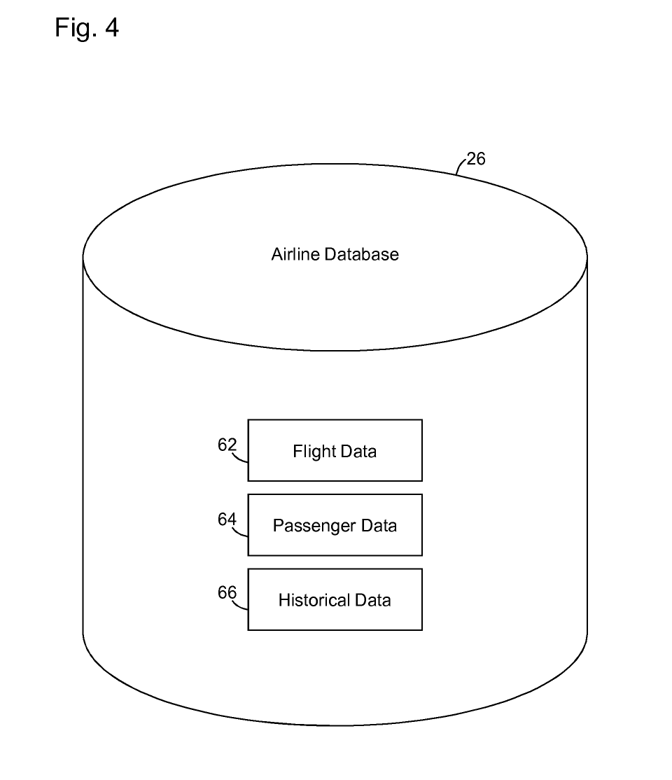

As shown in FIG. 4, the airline database 26 stores a range of information relating to upcoming flights. For each flight, stored flight data 62 includes the flight number, departure time, whether delayed, and the number of seats booked and available in each class, the duration of the flight and deadlines for flight ticket purchases and check-in. these rules may be tailored to specific airline requirements and also to different types of fights whether international or domestic where slightly different considerations may be required.

Passenger data 64 is also stored, including the following: passenger name, address, passport number, frequent flyer ID, billing information, email address, mobile phone number and so on. This is useful when a communication with the passenger (ticket holder) is required. Historical data 66 is also stored, including: historical average number of seats booked and available in each class for the same route on the same day of the week, historical late booking and late drop-off statistics on similar flights, the impact of weather and season on this route, and the average and distribution of seat prices in each class for this route.

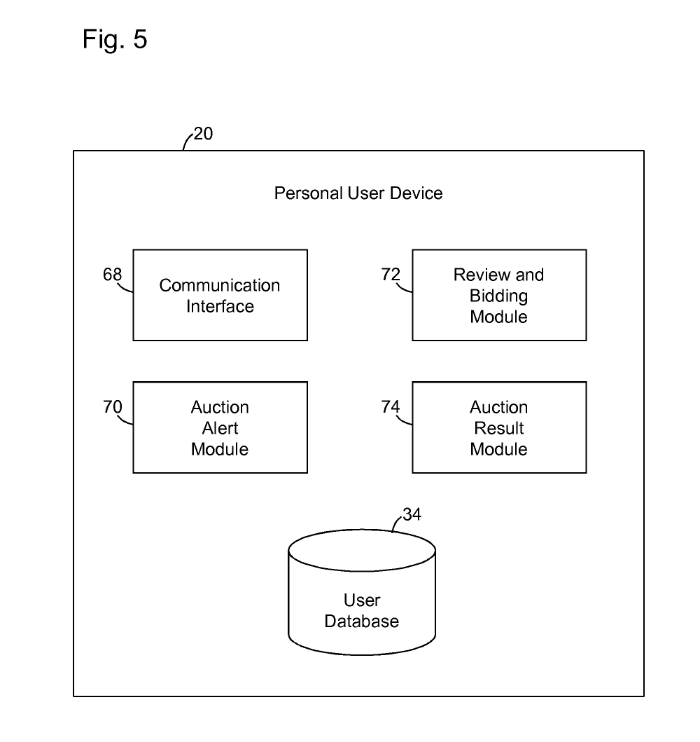

With reference to FIG. 5, the personal user device 20 includes the user database 34, a communication interface 68 for communications via the communication network 18, and various modules with processing functionality. An auction alert module 70 is arranged to receive an alert that there will be an auction on the user's booked flight. A review and bidding module 72 is arranged to receive an auction invitation from the auction server and to enable a user to review the details of the auction rules, terms and conditions and invitation to place bids. The review and bidding module 72 also enables a user to input bids to the personal user device 20 and to submit those bids to the auction server 12. An auction result module 74 is also provided for receiving the outcome of submitted bids, and for displaying these to the user. If the user's bid has been successful, the auction result module 74 receives and displays instructions for paying for and collecting a replacement ticket. These instructions may include simply presenting a unique identifier (such as a QR code identifier) received as a result of winning the auction to the departure gate or upgrade lounge for issuance of a new boarding pass an access to the upgraded facilities.

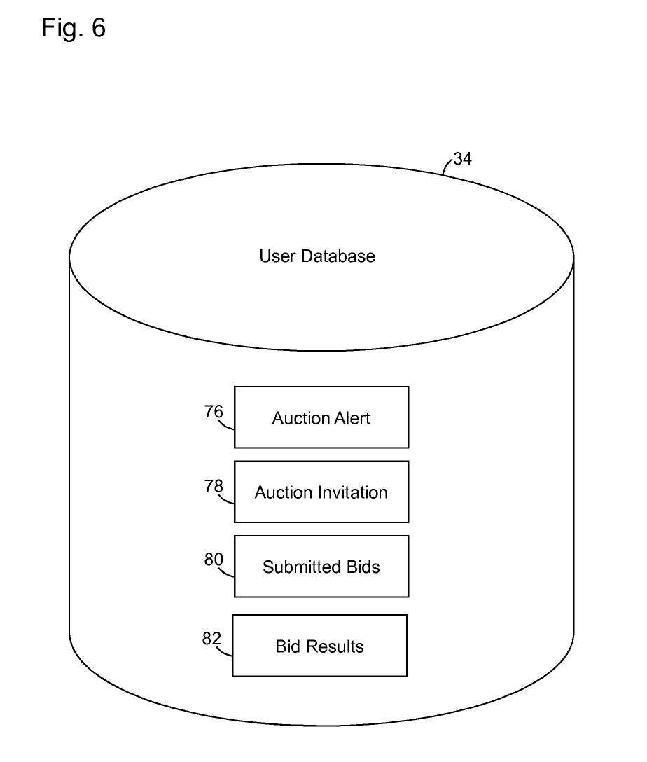

With reference to FIG. 6, the user database 34 stores an auction alert 76 if received, an auction invitation 78 if received, any submitted bids 80 and received bid results 82, including payment and collection information for successful bids. This information can be used to analyse a likelihood of success (based on historical data) when making a bid to better inform the traveller.

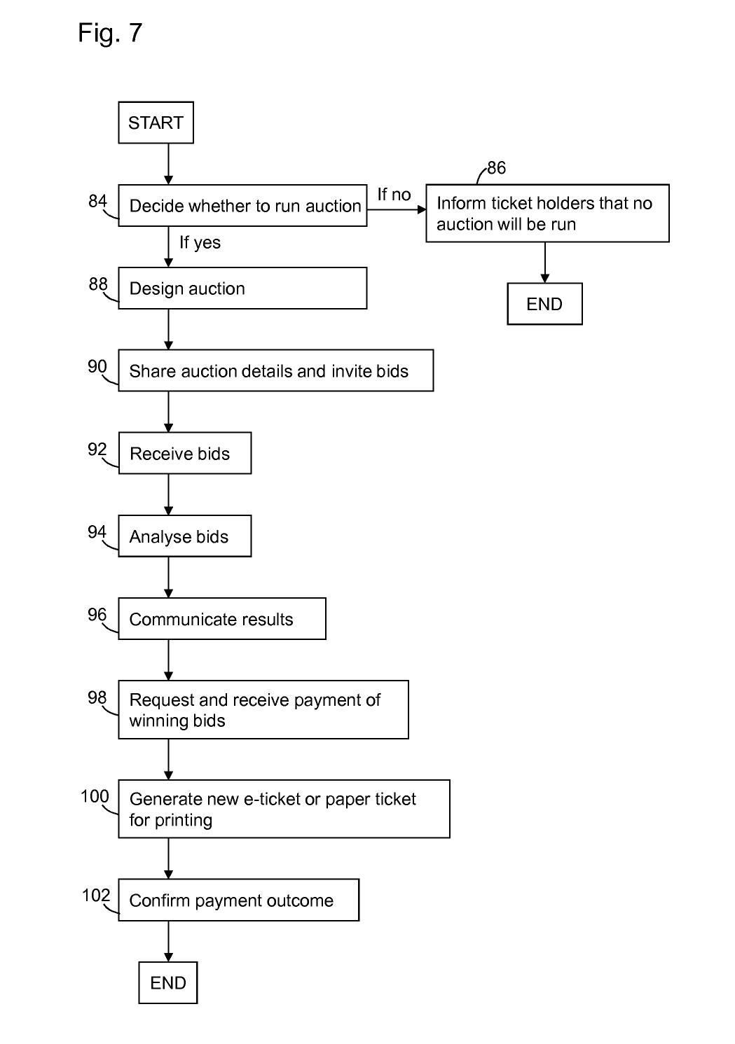

The activities of the auction server 12 during an auction process will now be described with reference to FIG. 7. To start the process, the auction decision module 38 of the auction server 12 decides at Step 84 whether to run an upgrade auction for a particular upcoming flight, and if so at what time ticket holders will be alerted that an auction will be taking place. By referring to the auction database 24, the auction decision module 38 takes into account relevant flight data 62, passenger data 64 and historical data 66, and determines a decision according to the auction set up rules 50. If it is determined that an auction will not be run, the auction server 12 informs at Step 86 ticket holders that no auction will be run on their flight and the process ends.

If it is determined that an auction will be run, the auction decision module 38 fixes the time at which ticket holders will be alerted that an auction is to be launched, and the auction design module 40 designs at Step 88 an auction for that flight. During the design at Step 88, the auction design module 40 refers to downloaded flight, passenger and historical data 54 and sets the various auction parameters 52 (such as which upgrades are available for auction and the deadline by which bids must be received) according to the auction set up rules 50. Once the auction has been fully defined, the auction server 12 shares at Step 90 the auction details with ticket holders (including holders of standby tickets) and invites the ticket holders to place bids. Depending on the available contact details and preferences of ticket holders, auction details and bid invitations may be shared by various forms of communication, including email, SMS, social media messaging such as Twitter or Facebook messaging and IM (instant messaging). Communication may be supported for example by any communications networks such as WiFi, GSM, 2G, 3G, 4G or Blutooth.

Bids are received at Step 92 by the bid analysis module 42 of the auction server 12. The bid analysis module 42 analyses at Step 94 the received bids according to the bid analysis rules 58 stored in the auction database 24. During the analysing at Step 94, the bid analysis module 42 refers to the timer module 44 to check that the received bids were all submitted by the deadline. Any late bids are excluded from the auction. Bids specify the ticket holder who made the bid, or on behalf of whom the bid was made—for example, a ticket holder in a family group of four people could place bids for their own ticket as well as for the tickets of each of their family members. During the analysing at Step 94, the bid analysis module 42 ranks the bids and identifies the number of winners and allocates new seats to the winners. If there is more than one upper class to which upgrades relate, the bids are ranked for the highest class, followed by the next class down and so on. For example, for a flight with first class, business class and economy, upgrades to the first class will be allocated to the highest bidders who submitted bids applying to the first class. Then, the remaining bids will be ranked to identify successful bids in respect of business class.

Once the bids have been fully analysed and new seat allocations have been identified, the communication interface 36 of the auction server 12 communicates at Step 96 the results of the auction including all new seat allocations to bidders and airline staff. For successful bidders, instructions on how to collect new tickets (which can be e-tickets or paper tickets) are provided. Unsuccessful bidders are informed that they have not won an upgrade on this occasion, and relevant airline staff are provided with the updated seat allocations together with the identities of the passengers who have been upgraded. During the communicating at Step 96 the auction server uses the stock of pre-determined messages 60 for communicating auction results.

The payment module 46 requests and receives at Step 98 payment of the winning bids, and subsequently generates at Step 100 new electronic tickets or initiates preparation of paper tickets ready for printing and collection by upgraded passengers, and finally confirms at Step 102 receipt of payment. Various payment methods are available: for example, payment using credit or debit card details stored on a personal mobile device; payment using a paypal account on a personal mobile device; swiping or using chip and pin payment with a credit or debit card at a point of sale terminal in the airport—for example at check in or at the boarding gate; payment by cash, bank cheques or travellers cheques; payment by mobile wallet or NFC technologies; payment by frequent flyer miles or other loyalty scheme points; and payment by foreign currencies.

For the issuance of new tickets prior to check-in and security, a unique authentication code—which may for example be provided as a new booking reference or a QR code—may be sent to the ticket holder, who can then be issued a new ticket and boarding pass at check-in upon presentation of the code. Alternatively, a new e-ticket can be sent to the ticket holder which they can display at check-in in order to collect their new boarding pass. For the issuance of new tickets after check-in and security, the ticket holder may be issued a unique authentication code or a new e-ticket which is displayed at the boarding gate where they will be given their new boarding pass. Once the ticket holder has their new boarding pass, the auction process is complete.

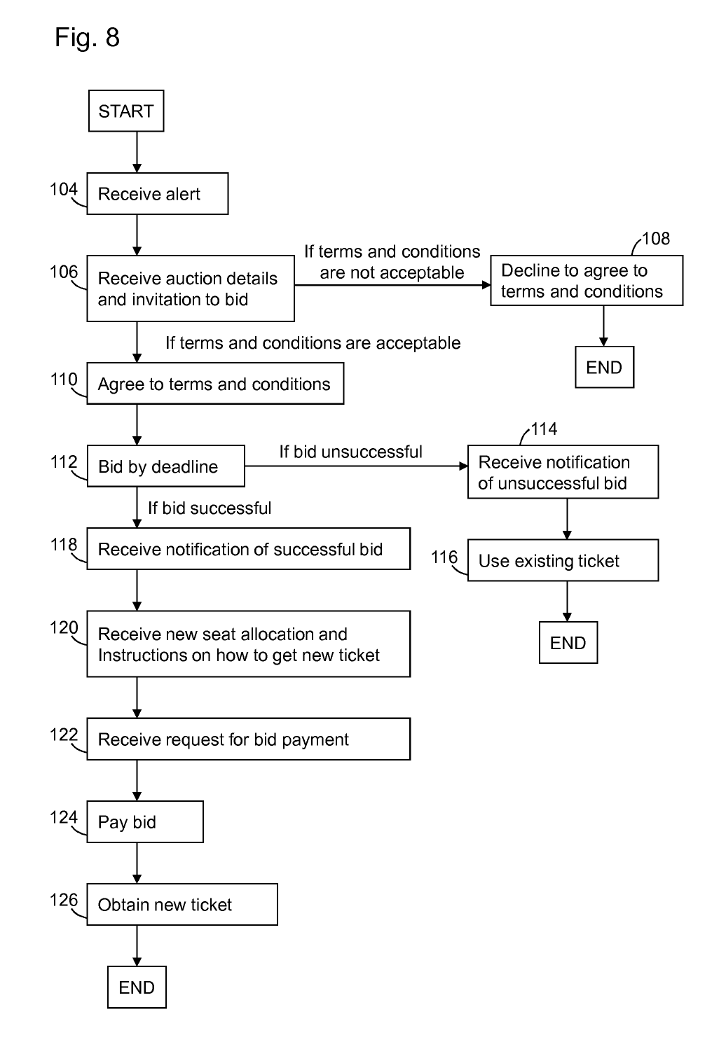

The activities at the personal user device 20 during the auction process will now be described with reference to FIG. 8. Equivalent activities may also be carried out by a ticket holder at the public terminal 22.

Initially, an alert is received at Step 104 indicating that an upgrade auction will be run on the passenger's flight. This alert can, for example, be received using a smartphone app or by email, text or other messaging services. Subsequently, an invitation to place a bid is received at Step 106, together with full details of the auction rules, auction terms and conditions and deadline by which all bids must be submitted.

If the passenger wants to take part, he or she must agree at Step 108 to the terms and conditions. This could be done by sending a text message in a required format such as ‘A’ for accept or ‘Yes’, or an accept option could be selected from a smartphone app which then transmits the accept message to the auction server. If the passenger declines at Step 110 to agree to the terms and conditions the process ends there.

The passenger then decides which upgrade he or she wants to bid for and decides a bid price. There may be more than one upgrade type, depending on the number of ticket classes on that flight, the passenger's current ticket class and the class he or she wants to bid for. An economy passenger can make multiple bids, for example one for first class and another for an intermediate class such as club/business or even premium economy, depending on the airline and the flight. The passenger selects which upgrade type or types to bid for, enters the amount of the bid, and bids at Step 112 by the deadline. Again, this can be implemented using an app, by text or by logging on to a website or similar.

After the bidding deadline, when all bids have been analysed and winners identified, the passenger receives an auction result message. If the bid was not successful, a notification of the unsuccessful bid is received at Step 114 and the passenger uses at Step 116 his or her existing ticket. The process then ends there.

If the bid was successful, the passenger receives at Step 118 a notification of the successful bid and receives at Step 120 a new seat allocation with instructions on how to collect the new ticket. A request for bid payment is received at Step 122, and to complete the process the passenger pays at Step 124 their bid and obtains at Step 126 their new ticket. Alternatively, all of the passenger's payment information may already be available to the payment module 46 from the airline computer system 14 or the 3^{rd} party domain. In this case the user simply indicates confirmation that they accept the upgrade and then the payment is made using the account or credit card information already known to the payment module 46.

Further embodiments of the invention will now be described.

In a further embodiment, the decision by the auction decision module 38 whether to run an auction for a given flight may be overridden by certain airline staff or by a central auction management team. Alternatively, the decision may be taken by certain airline staff or such a management team. Factors that airline staff or a management team might take into account include season, economic outlook, and current business objectives (for example, a balance between revenue and profits).

In a further embodiment, participation in the upgrade auction is restricted to a subset of passengers, such as frequent flyers, frequent flyer gold or platinum members, frequent flyers of another airline companies, passengers whose contact details are known by the airline company, or passengers who have opted in to be included in such auctions. Participation may also be restricted to passengers flying on specific classes—for example, the auction could be applicable only to business class customers who wish to bid for seats in first class.

In a further embodiment, the rules of the auction may be varied according to the status of the participating passengers. For example, a frequent flyer with gold status may have a portion of their bid—for example 20%—that will not be invoiced in case their bid is successful. This is a way of providing discounting privileges to certain classes of passengers.

In a further embodiment, auctions may be restricted to certain flights, based for example on one or more of distance (for example, long haul flights versus short haul flights), geography (within a specific country, between countries in the same continent, between countries on different continents), the historic percentage of empty seats on that route, profitability of that flight, the frequency of flights to a specific destination.

In a further embodiment, the auction may apply only to un-booked (available) seats in a certain category of classes. For example, an auction may be restricted to upgrades to business class, even if there are also un-booked seats in first class.

In a further embodiment, the auction may be restricted within a particular class to a sub-set of the un-booked seats. This enables one or more un-booked seats to be reserved for late bookings—as is common, for example, in first class for certain routes.

In a further embodiment, passengers may be allowed to bid not just for a generic seat but also for a specific seat number (for example by the right window on the second row).

In a further embodiment, the deadline for submitting bids may be varied depending on various factors such as the duration of the flight, the time of the year, and local restrictions with regards to check-in and boarding deadlines.

In a further embodiment, passengers are given the option to bid for a “standard upgrade” (for example from economy class to the next class upward, such as premium economy) to a “multiple upgrade” (for example from economy class to first class).

In a further embodiment, an auction model is selected from the following options and used on all participating routes: sealed bids (concealed to participants) or open bids (revealed to all participants); Dutch auction, Vickrey auction, proxy bidding, forward and reverse auctions or Japanese auction, or a different auction typology.

In a further embodiment, certain information with regards to the flight is disclosed to potential bidders prior to the start of the auction. This information would help participants to select what they think is an adequate price for the bid, and could include the number of seats available in each upgrade class, the number of passengers in the plane, the number of passengers who have expressed interest in participating in the auction, and the price of the winning bidder for the last flight on the same route and on the same day.

In a further embodiment, a reserve price is set for an upgrade. This is the lowest price that the seller is willing to accept for the upgrade. In a further embodiment, a minimum bidding price is set for an upgrade.

In a further embodiment, passengers are charged a fee for their participation in the auction. This fee may differ depending on the status of the passenger—for example a “standard” passenger may be charged one pound while a frequent flyer may be able to bid for free.

In a further embodiment, payments from the winning bidders may be collected after the flight has taken place, for example by sending an invoice a few days or weeks later.

In a further embodiment, winning bidders are entitled to choose the position of their new seat from a seating plan of the available seats in one of the upper classes.

In a further embodiment, statistics of some or all previous auctions are shared with participating passengers or with all passengers. Such statistics may also be made available to the general public.

In all embodiments, there is interaction between participating passengers and the auction server. For example, communications are sent to passengers when they are invited to bid, when providing instructions and rules, when announcing the beginning of the auction, keeping them informed of the progress in the case that the auction is not sealed, and providing the results to both successful and unsuccessful bidders. One or a combination of several communication means may be used.

Communication channels that may be used by at least some embodiments include: email, SMS, messages on social media accounts (such as direct messages on Twitter or Facebook), instant messages (such as Blackberry BBM instant messages or ICQ), video calls (such as iChat on the Apple iOS), announcements by staff in the airport or at the airline company's desks, alerts on interactive kiosks, phone calls, RSS feeds, text on printed tickets, face-to-face conversation between the airline company staff and passengers. In some embodiments, participating passengers are able to interact with the auction server directly by using their personal user devices, portable computers, or tablets, or alternatively by using a public computer terminal. Additionally or alternatively, participating passengers may interact indirectly by talking to airline staff who themselves interface directly with a terminal on the passenger's behalf.

It is to be appreciated that the various embodiments that have been described may be combined in any combination.

It will be appreciated that the embodiments described herein are not to be considered limiting as the person skilled in the art could readily modify the embodiments to take different forms to that described here, without departing from the spirit and scope of the invention as defined in the appended claims.

1. An auction server for auctioning airline ticket upgrades, the server comprising:
an upgrade data gathering module for gathering data relating to available airline ticket upgrades for a specific airline flight;
a communication interface for communicating auction information with existing airline ticket holders; the communication interface being arranged to receive at least one bid from at least one ticket holder for an airline ticket upgrade, and
a bid analysis module for analysing the at least one bid for an airline ticket upgrade, the bid analysis module being arranged to determine a winning bid and its ticket holder to whom the airline upgrade ticket will be issued.

2. An auction server of claim 1, wherein the communications interface is arranged to communicate with existing airline ticket holders of the specific airline flight such that they are presented with an opportunity to bid on an upgrade on a flight for which they already have a ticket.

3. An auction server of claim 1, wherein the communications interface is arranged to communicate a deadline time for receiving a bid for the airline ticket upgrade.

4. An auction server of claim 1, wherein the communications interface is arranged to notify the existing airline ticket holder of the outcome of the auction.

5. An auction server of claim 1, wherein the communications interface is arranged to send an existing ticket holder who has been successful in winning an upgraded airline ticket, an authentication upgrade code for use in confirming the success of the airline ticket holder to third party authentication devices.

6. An auction server of claim 1, wherein the communications interface is arranged to communicate via a web browser of a processing device of the ticket holder.

7. An auction server of claim 1, wherein the communications interface is arranged to communicate with a portable telecommunications device of the ticket holder.

8. An auction server of claim 1, wherein the bid analysis module is arranged to determine whether any of the bids for upgrades on the specific airline flight have exceeded a predetermined threshold value and to prevent any ticket upgrade being issues if the threshold value has not been met by a highest bid.

9. An auction server of claim 8, wherein the threshold value is a value between a full price of an upgrade class of the auctioned ticket upgrade less the price already paid by the airline ticket holder and the price of a current class of the ticket held by the airline ticket holder less the price already paid by the airline ticket holder.

10. An auction server of claim 1, wherein the bid analysis module is arranged to determine whether any of the bids has been received before a deadline time which is set with respect to a departure time of the specific airline flight.

11. An auction server of claim 1, wherein the bid analysis module is arranged to analyse a plurality of bids for a plurality of airline ticket upgrades, determine a plurality of winning bids and match each winning bid to a corresponding airline ticket upgrade.

12. An auction server of claim 1, wherein the upgrade data gathering module is arranged to receive information relating to the specific airline flight, including a departure time of the specific airline flight.

13. An auction server of claim 1, wherein the upgrade data gathering module is arranged to obtain data relevant to ticket holders for the specific airline flight.

14. An auction server of claim 13, wherein the upgrade data gathering module is arranged to gather data from an airline ticketing system.

15. An auction server of claim 13, wherein the upgrade data gathering module is arranged to gather data from a third-party ticketing system.

16. An auction server of claim 1, further comprising an auction decision module for determining whether to run the airline ticket upgrade auction for a specific airline flight.

17. An auction server of claim 16, further comprising an auction design module arranged to select an auction from the group comprising a forward auction, a reverse auction, a closed auction, an open auction, a Dutch Auction, and a Vickrey auction.

18. An auction server of claim 17, wherein the auction design module is arranged to calculate a deadline time for the auction using a departure time of the specific airline flight.

19. An auction server of claim 18, wherein the auction design module is arranged to determine the deadline time as 30 minutes before the departure time of the specific airline flight.

20. An auction server of claim 1, further comprising a payment module for accepting payment for an upgrade airline ticket from a successful bidder, the payment module being arranged to use information obtained by the upgrade data gathering module.

21. An auction server of claim 20, wherein the payment module is arranged to access a payment account of the successful bidder, details of which have been obtained from an airline ticketing system or a third-party ticketing system.

22. A method of auctioning airline ticket upgrades to existing airline ticket holders, the method being implemented using a processor and comprising:
gathering data relating to available airline ticket upgrades for a specific airline flight;
communicating auctioning information to existing airline ticket holders;
receiving and analysing at least one bid from a ticket holder directed to an airline ticket upgrade;
determining a winning bid and its ticket holder to whom the airline upgrade ticket will be issued.

23. A method of claim 22, wherein the communicating step comprises communicating with existing airline ticket holders of the specific airline flight such that they are presented with an opportunity to bid on an upgrade on a flight for which they already have a ticket.

24. A communications device for interacting with an auction of airline ticket upgrades, the device being arranged to communicate auction information to and from an auction server and the device comprising:
an auction alert module for receiving notification of the existence of the auction of airline ticket upgrades for a specific airline flight;
a review and bidding module for creating at bid for the existing ticket holder for an airline ticket upgrade and sending the same back to the auction server; and
an auction result module for presenting an outcome of the bid received from the auction server.

25. A communications device of claim 24, wherein the review and bidding module is also arranged to present information about the auction and its rules and is arranged to receive an acceptance of the rules from the device user.

26. A communications device of claim 24, wherein the auction result module is arranged to provide instructions to enable collection and payment for an airline ticket upgrade for a successful airline ticket upgrade bid.

27. A communications device of claim 24, further comprising a database for storing auction information relating to submitted bids and bid results.

28. A communications device of claim 27, wherein the database is arranged to store a unique authentication code received from the auction server which is to be used to authenticate the successful bid in order to receive the upgrade airline ticket.

29. A communications device of claim 24, wherein the device comprises a smart phone or tablet computer and the auction alert module, the review and bidding module, and the auction result module are provided by a downloadable application for configuring the smart phone or tablet computer.

30. A combination of an auction server of claim 1 and a communications device of claim 24.

31. An auction server for auctioning event ticket upgrades, the server comprising:
an upgrade data gathering module for gathering data relating to available ticket upgrades for a specific event;
a communication interface for communicating auction information with existing event ticket holders; the communication interface being arranged to receive at least one bid from at least one event ticket holder for an event ticket upgrade, and
a bid analysis module for analysing the at least one bid for an event ticket upgrade, the bid analysis module being arranged to determine a winning bid and its ticket holder to whom the event upgrade ticket will be issued.
